(19) United States
(12) Patent Application Publication
(10) Pub. No.: US 2002/0116847 A1
(43) Pub. Date: Aug. 29, 2002

(54) Colorful pyramidal waterglobe

(76) Inventor: Jen-Yen Yen, Lu Chou City (TW)

Correspondence Address: RABIN & CHAMPAGNE, PC, 1101 14TH STREET, NW, SUITE 500, WASHINGTON, DC, 20005, US

(21) Appl. No.: 09/790,563

(22) Filed: Feb. 23, 2001

(51) Int. Cl. G09F 19/00

(52) U.S. Cl. 40/406; 40/409

(57) ABSTRACT

A colorful pyramidal waterglobe has a base. A transparent pyramidal body filled with water is mounted on the top of the base, inside of which an air pump, a projection lamp and two concentrically revolving rounding boards are contained. Air is sprayed out from an air spray nozzle that passes through top of the base. A conical air bubble duct is fitted to the top of the base and inside the transparent pyramidal body, and several side holes are disposed on the bottom portion of the conical air bubble duct. Accordingly, small air bubbles gather and combine into bigger bubbles as they rise up along the conical air bubble duct to generate a better visual effect. The windows on four sides of the base also glare and amplify the panel drawings on the revolving rounding boards.

### BACKGROUND OF THE INVENTION

I. Field of the Invention

This invention relates generally to a colorful pyramidal waterglobe and, more specifically, to a colorful pyramidal waterglobe that generates multiple size and color changing air bubbles in a tower shape structure. On the bottom of the structure also glares rotating drawings. The combination features make the colorful pyramidal waterglobe a decoration with beautiful and elegant visual effect.

II. Description of the Prior Art

Heretofore, it is known in office, night club and hotel or residential is generally to place a water-filling decoration, it is believed such arrangement could bring luck. Waterglobe is the most popular one, most of the waterglobe known is to have color lamp inside or to have air pump generating air bubbles, such scheme is too plain to be a decorator. Simple air bubbles without processes appear to be dull and disordered, and can not really offer nice vision.

### SUMMARY OF THE INVENTION

It is therefore a primary object of the invention to provide a colorful pyramidal waterglobe compromising a base, a transparent pyramidal body filled with water is on the top of the base, inside of the base contains an air pump, a projection lamp and two concentrically revolving rounding boards. Air is sprayed out from an air spray nozzle that passes through top of the base, a conical air bubble duct is on the top of the base and inside the transparent pyramidal body, and several side holes are on the bottom portion of the conical air bubble duct. Small air bubbles gather and combine into bigger bubbles as they rise up along the conical air bubble duct to generate better visual effect. The windows on four sides of the base also glare and amplify the panel drawings on the revolving rounding boards, and this increases the joyful atmosphere.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the present invention;

FIG. 2 is a physical illustration of the present invention;

FIG. 3 is a cross-sectional view of an embodiment of the present invention; and

FIG. 4 is an internal view of another embodiment of the present invention.

### DESCRIPTION OF THE PREFERRED EMBODIMENT

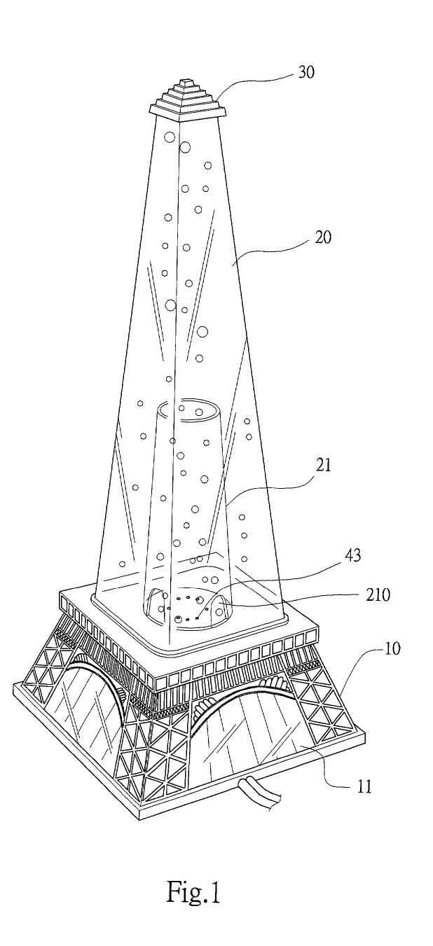

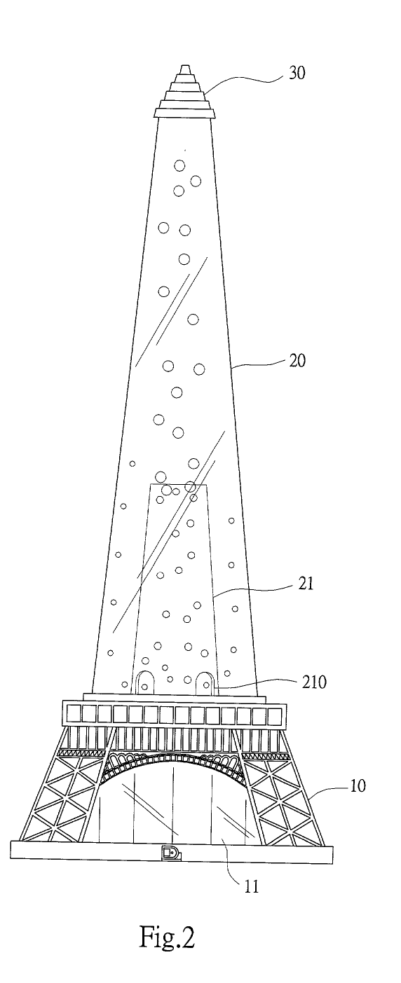

Referring to FIG. 1 and FIG. 2, the present invention is composed of a base 10 in square tower shape. A plurality of windows are fitted to its four sides and several convex lens 11 are mounted on each of the windows. A transparent pyramidal body 20 is arranged on the top of the base 10 and along the brim thereof while the top of the transparent pyramidal body 20 is covered with a cap 30. The combination of the base 10, the transparent pyramidal body 20 and the cap 30 appears in a pyramidal tower shape. A conical air bubble duct 21 is mounted on the top plate of the base 10 and inside the transparent pyramidal body 20 while several side holes 210 are disposed around the bottom side of the air bubble duct 21.

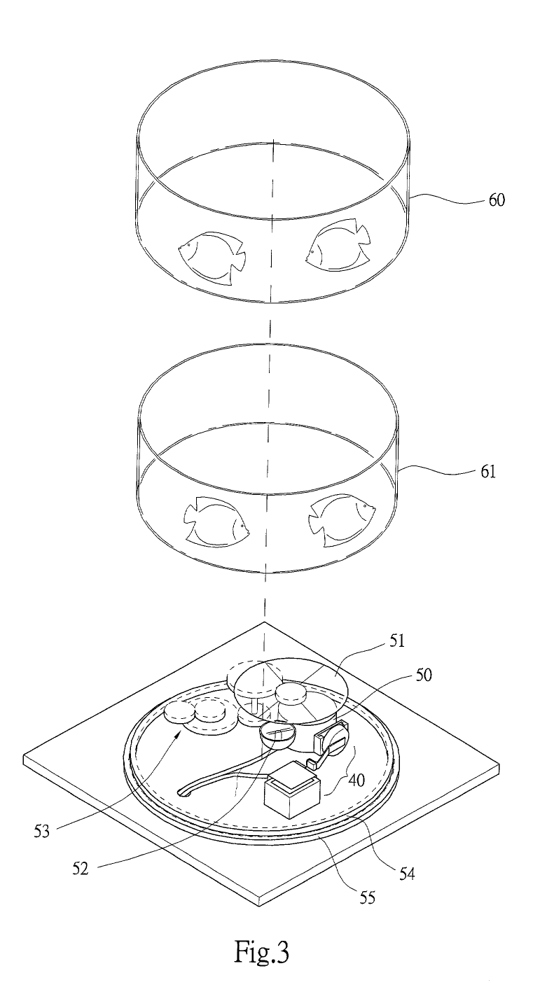

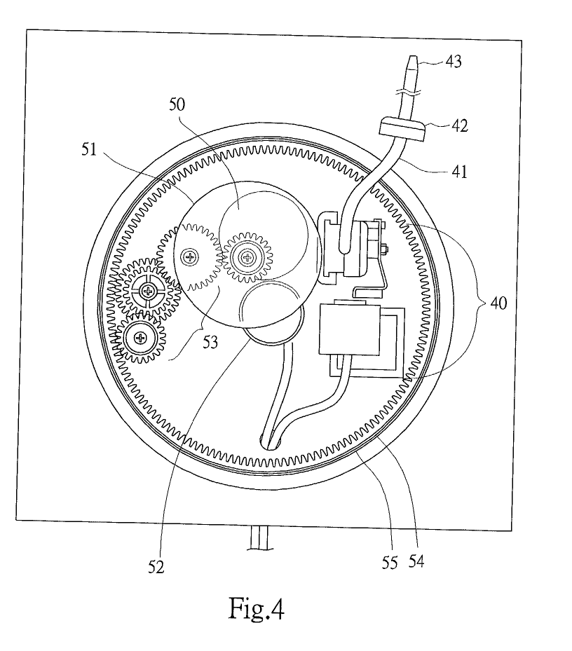

Referring to FIG. 3 and FIG. 4, they indicate the interior portion of the base 10. An air pump 40 connects to main power wire and to an air pipe 41. A nonreturn valve 42 is installed in the middle of air pipe 41 while an air spray nozzle 43 is fitted to the top end of the air pipe 41. The air spray nozzle 43 passes through the top plate of the base 10, as shown in FIG. 1, and extends to the center of conical air bubble duct 21. Main power wire also connects in parallel to a motor 50 and a projection lamp 52, and the motor 50 drives a rotary color platter 51 and a gear set 53. The rotary color platter 51 is situated above the projection lamp 52 to generate the changing multicolor light. The gear set 53 is in contact with a big and small cogwheels 54, 55 to enable them to rotate clockwise and counterclockwise respectively. The big and small cogwheels 54, 55 are concentrically arranged, and two revolving rounding boards 60, 61 are attached firmly to the cogwheels 54, 55 respectively and painted with panel drawings like fishes. Those drawings are rotating in alternate directions, amplified and glared by convex lens 11, as shown in FIG. 1.

Referring to FIG. 2, air bubbles spray up from the base 10, most of them will pass through the conical air bubble duct, gather and combine into larger bubbles as they go higher and higher. Other air bubbles pass through side holes 210 and also go up; the combination of multiple air bubbles with reflected changing color light makes an elegant and magnificent picture.

While a preferred embodiment of the invention has been shown and described in detail, it will be readily understood and appreciated that numerous omissions, changes and additions may be made without departing from the spirit and scope of the invention.

What is claimed is:

1. A colorful pyramidal waterglobe comprising:
a base;
a transparent pyramidal body filled with water being mounted on top of said base;
a pump installed within said base for spraying the air upward through the top of said base; and
a motor used to drive a rotary color platter and a gear set, said rotary color platter being located above a projection lamp to generate the changing multicolor light, said gear set being in contact with a big and small cogwheels to enable them to rotate clockwise and counterclockwise respectively, said big and small cogwheels being concentrically arranged, two revolving rounding boards being attached firmly to said cogwheels respectively;
wherein said base is formed in a square tower shape, and a plurality of windows are fitted to four sides thereof, and said transparent pyramidal body is cone-shaped so that the combination of said base and said transparent pyramidal body appears in a pyramidal tower shape; and
wherein a conical air bubble duct is uprightly mounted within said transparent pyramidal body of the top plate of said base while several side holes are disposed around the bottom side of said air bubble duct, and an air spray nozzle is just situated within the bottom of said conical air bubble duct so that air bubbles spray up from said base, and most of them will pass through the conical air bubble duct, gather and combine into larger bubbles as they go higher and higher while the other air bubbles pass through said side holes and also go up.

2. The colorful pyramidal waterglobe recited in claim 1, wherein an opening on top of said conical air bubble duct is covered with a cap.

3. The colorful pyramidal waterglobe recited in claim 1, wherein said windows includes convex lenses to amplify drawings on said revolving rounding boards.
